(19) United States
(12) Patent Application Publication
(10) Pub. No.: US 2017/0091155 A1
(43) Pub. Date: Mar. 30, 2017

(54) FONT TYPEFACE PREVIEW

(71) Applicant: Microsoft Technology Licensing, LLC., Redmond, WA (US)

(72) Inventors: Shashidhar Rajashekara, Sammamish, WA (US); Ziad Khalidi, Redmond, WA (US); Simon James Daniels, Seattle, WA (US); Shanshan Liu, Redmond, WA (US); Abhijit Nemichand Gore, Redmond, WA (US); Sami Azzam, Bothell, WA (US); Kumaran Bhakthavachalam, Sammamish, WA (US)

(73) Assignee: Microsoft Technology Licensing, LLC., Redmond, WA (US)

(21) Appl. No.: 14/871,939

(22) Filed: Sep. 30, 2015

(51) Int. Cl. G06F 17/21; G09G 5/22; G06F 3/0484; G06F 17/22; G06F 3/0482

(52) U.S. Cl. CPC G06F 17/214; G06F 17/212; G06F 17/2205; G06F 3/0482; G06F 3/04842; G09G 5/225; G09G 2370/02

(57) ABSTRACT

Generating a preview representative of a font is provided. A font typeface preview engine generates a preview font file comprising a plurality of font typeface preview elements, wherein each font typeface preview element is associated with a cloud-based font. The font typeface preview engine further generates a mapping file comprising location data mapping each font to a storage location of its associated font typeface preview element in the preview font file. The preview font file and the mapping file are transmitted to a client application executing on a computing device for rendering the plurality of font typeface preview elements as representations of the fonts in a font selection menu. The size of the preview font file can be kept very low. Thus, the computing device is enabled to render the font typeface preview elements with high fidelity, while saving memory allocation for fonts and reducing processor load.

### BACKGROUND

A cloud-based font delivery/streaming service enables applications to download fonts on demand, thereby reducing application package size and disk footprint. Typically, applications provide a font selection menu comprising a list of fonts available to the application from which a user can select a desired font. To provide hints to the user as to what the fonts look like prior to committing to a font, it is desirable for the application to render previews of the font names (or other representations of the fonts) in their own typefaces. When a font file of a given font is stored on the cloud (i.e., not locally), rendering a high fidelity preview of the font in its own typography can be difficult.

### SUMMARY

This summary is provided to introduce a selection of concepts in a simplified form that are further described below in the Detailed Description section. This summary is not intended to identify key features or essential features of the claimed subject matter, nor is it intended as an aid in determining the scope of the claimed subject matter. Aspects are directed to an automated system, method, and device for generating an independent preview font file for presenting font typeface preview elements representative of cloud-based fonts in a font selection menu.

In some examples, a font system includes one or more processors for executing programmed instructions, memory coupled to the one or more processors for storing program instruction steps for execution by the computer processor, a font typeface preview engine for: generating a preview font file, the preview font file comprising a plurality of font typeface preview elements, wherein each font typeface preview element is associated with a font; and generating a mapping file comprising location data mapping each font to a storage location of its associated font typeface preview element in the preview font file.

In some examples, a method for generating an independent preview font file for presenting font typeface preview elements representative of cloud-based fonts in a font selection menu includes: generating a preview font file, the preview font file comprising a plurality of font typeface preview elements, wherein each font typeface preview element is associated with a font; and generating a mapping file comprising location data mapping each font to a storage location of its associated font typeface preview element in the preview font file.

In some examples, one or more computer storage media storing computer-usable instructions that, when used by one or more computing devices, cause the one or more computing devices to perform a method for: generating an independent preview font file for presenting font typeface preview elements representative of cloud-based fonts in a font selection menu, the method comprising: generating a preview font file, the preview font file comprising a plurality of font typeface preview elements, wherein each font typeface preview element is associated with a font; and generating a mapping file comprising location data mapping each font to a storage location of its associated font typeface preview element in the preview font file.

In some examples, the font system provides the preview font file and the mapping file to a client application executing on a client computing device for rendering the plurality of font typeface preview elements as representations of the fonts in a font selection menu, wherein the client computing device does not include the fonts. In some examples, the font system receives an indication of a selection of font, and transmits a font file including a plurality of glyphs in the typeface of the selected font to the client application executing on the client computing device.

By generating a plurality of font typeface preview elements, wherein each element is representative of an available cloud-based font and comprised of a subset of glyphs of the font, and packaging and providing the plurality of font typeface preview elements in a preview font file, the size of the preview font file can be kept very low. Thus, a computing device receiving the preview font file is enabled to render the plurality of font typeface preview elements in a font selection menu with high fidelity, while advantageously saving local memory allocation for fonts, minimizing the disk footprint, and reducing processor load. For example, the computing device is enabled to render the plurality of font typeface preview elements rather than downloading all of the available fonts to the client computing device or loading and rendering each glyph of each font name (or other representations of the fonts), which requires a lot of memory allocation and processing.

Rendering the plurality of font typeface preview elements in a font selection menu provides an intuitive user interface for users. For example, displaying representations of fonts that are not locally stored on a computing device in the fonts' own typefaces provides users with a high fidelity visual clue of the fonts and typefaces available, thus improving usability of the font selection menu.

Examples are implemented as a computer process, a computing system, or as an article of manufacture such as a computer program product or computer readable media. According to an aspect, the computer program product is a computer storage media readable by a computer system and encoding a computer program of instructions for executing a computer process.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the claims.

### BRIEF DESCRIPTION OF THE DRAWINGS

The accompanying drawings, which are incorporated in and constitute a part of this disclosure, illustrate various aspects. In the drawings:

FIG. 1 is a simplified block diagram showing components of an example operating environment including a font system for generating and providing an independent preview font file for presenting font typeface preview elements representative of cloud-based fonts in a font selection menu;

FIG. 2 is a simplified block diagram showing various components of an example font typeface preview engine;

FIG. 3A is a simplified block diagram showing a glyph and property extractor extracting a subset of glyphs from a font file;

FIG. 3B is a simplified block diagram showing a preview font generator and shaping engine generating a single-glyph font typeface preview element from the subset of glyphs;

FIG. 3C is a simplified block diagram showing a plurality of font typeface preview elements displayed in a font selection menu;

FIG. 4 is a graphical representation of a flow of data in an example font typeface preview element generation system;

FIG. 5A is a flow chart showing general stages involved in an example method for generating and providing an independent preview font file for presenting font typeface preview elements representative of cloud-based fonts in a font selection menu;

FIG. 5B is a flow chart showing general stages involved in an example method for providing a font file to a client application executing on a client computing device;

FIG. 6 is a block diagram illustrating example physical components of a computing device;

FIGS. 7A and 7B are simplified block diagrams of a mobile computing device; and

FIG. 8 is a simplified block diagram of a distributed computing system.

### DETAILED DESCRIPTION

The following detailed description refers to the accompanying drawings. Wherever possible, the same reference numbers are used in the drawings and the following description refers to the same or similar elements. While examples may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description is not limiting, but instead, the proper scope is defined by the appended claims. Examples may take the form of a hardware implementation, or an entirely software implementation, or an implementation combining software and hardware aspects. The following detailed description is, therefore, not to be taken in a limiting sense.

Aspects of the present disclosure are directed to a method, system, and computer storage media for generating an independent preview font file for presenting font typeface preview elements representative of cloud-based fonts in a font selection menu. In some examples, a font typeface preview engine includes: a font loader for loading one or more font files from a font database; a glyph and property extractor for extracting a subset of glyphs and character properties from each font file; a preview font generator for generating a single-glyph font typeface preview element for each font from each subset of glyphs according to the character properties; a preview font package generator for generating a preview font file and storing the one or more generated font typeface preview elements in the preview font file; and a mapping file generator for mapping each available font to a location of its associated font typeface preview element in the preview font file. In some examples, the font typeface preview engine further includes an output engine for transmitting the preview font file to a client application executing on a client computing device.

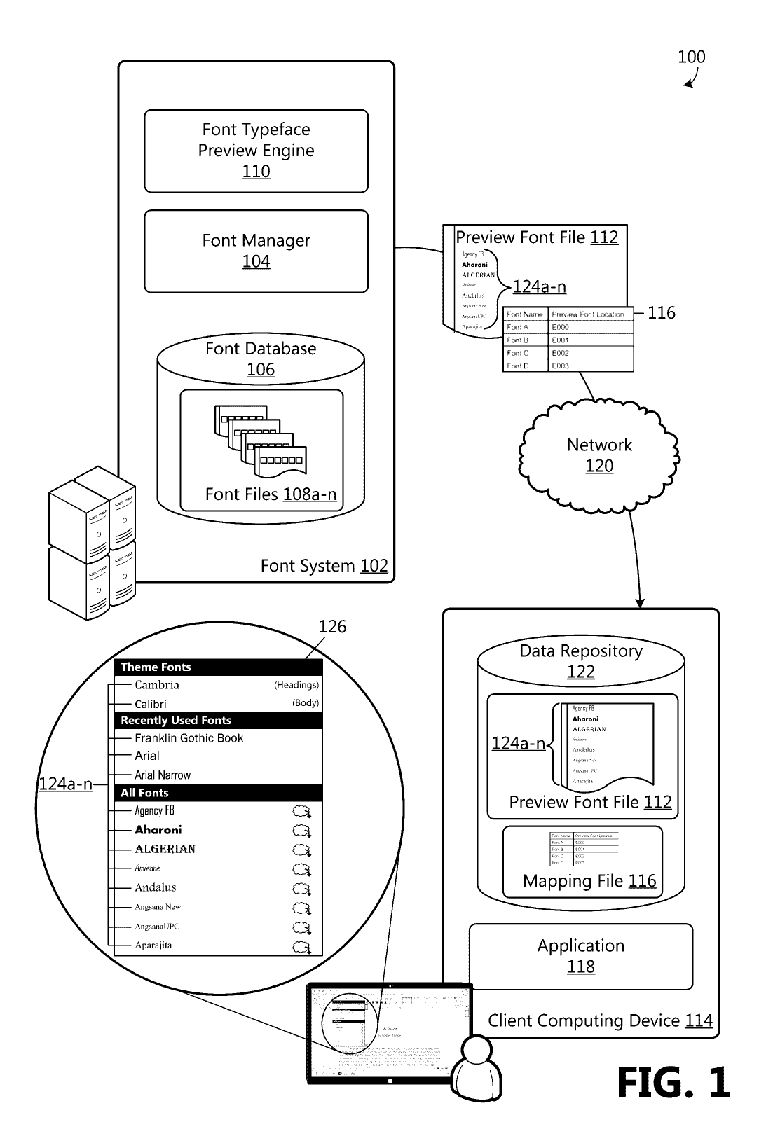

With reference now to FIG. 1, a simplified block diagram of one example of an operating environment 100 for generating an independent preview font file for presenting font typeface preview elements representative of cloud-based fonts in a font selection menu. The illustrated example includes a font system 102 comprising a font typeface preview engine 110 and a font manager 104. The font system 102 further includes a font database 106 illustrative of a general purpose data storage unit or system for storing a collection of font files 108a-n (collectively, 108). According to examples, each font file 108 is an electronic data file comprising a set of glyphs of a font and font properties or rules (herein referred to a character properties). According to an aspect, glyphs of a font typically share a common design element or typeface, and a font is generally named after its typeface. The character properties for a font provide logic associated with how to put the glyphs together into visually pleasing and meaningful words or sets. According to an aspect, the font files 108 include outline or vector fonts that comprise lines and curves that define the boundaries of glyphs. Accordingly, the glyphs of a vector font are scalable to any size.

In one example, the font database 106 is a single device at a single location, for example, on a single server. In another example, the font database 106 includes a plurality of storage devices that are distributed among different locations, for example, on a plurality of distributed servers. In some examples, the font typeface preview engine 110, the font manager 104, and the font database 106 are located on a single computing device or server. In other examples, the font typeface preview engine 110, the font manager 104, and the font database 106 are distributed across a network on multiple computing devices, servers, or data stores.

According to an aspect, for each font file 108, the font typeface preview engine 110 is operable to load the font file 108 from the font database 106, extract a subset of glyphs and character properties from the font file 108, and generate a single-glyph font typeface preview element 124a-n (collectively, 124) representative of the font. In some examples, the subset of glyphs includes the glyphs in the font's name and in the typeface of the font. For example, the preview font for the font “Arial” includes the glyphs “A,” “r,” “i,” “a,” and “I” combined into a single glyph in the Arial typeface. The font typeface preview engine 110 is further operable to package each generated font typeface preview element 124 into a preview font file 112, and generate a mapping table file 116 for mapping the name of each font to the storage location of the font typeface preview element 124 in the preview font file 112.

According to an aspect, the font system 102 is operable to provide the preview font file 112 comprising the generated font typeface preview elements 124 and the mapping file 116 to one or more applications 118 executing on a client computing device 114. In some examples, an application 118 executing on the client computing device 114 downloads the preview font file 112 from the font system 102. The font system 102 is operable to transport the preview font file 112 and the mapping file 116 to the client computing device 114 over a distributed computing network 120, such as the Internet or an intranet. In other examples, the font system 102 provides the preview font file 112 for packaging with a client application 118 at build time of the client application 118.

Although illustrated as a tablet computing device in FIG. 1, as should be appreciated, the client computing device 114 may include any suitable computing device, such as a desktop computer, laptop computer, tablet computer, handheld computing device, mobile communication device, wearable device, gaming device, and the like. According to examples, the client computing device 114 is operable to execute one or more client applications 118, such as, but not limited to, electronic mail and contacts applications, word processing applications, spreadsheet applications, database applications, slide presentation applications, drawing or computer-aided drafting application programs, personal information management applications, Internet browser applications, etc.

In some examples, the client application 118 is an application operable to reference the mapping file 116 for locating font typeface preview elements 124 representative of fonts for displaying in a font selection menu 126, and render the font typeface preview elements 124 in a font selection menu 126 such that the fonts represented by the font typeface preview elements 124 are displayed in their own typefaces. The data repository 122 is illustrative of a general purpose data storage unit or system for storing the preview font file 112 and the mapping file 116.

Upon receiving an indication of a selection of a font typeface preview element 124 from the font selection menu 126, the client application 118 is further operable to access the font file 108 associated with the font represented by the selected font typeface preview element 124 via a font manager 104. For example, the client application 118 makes a request to the font manager 104 for the selected font. The font manager 104 receives the request, retrieves the font file 108 residing in the font database 106, and transmits the font file 108 to the client application 118 via the distributed computing network 120.

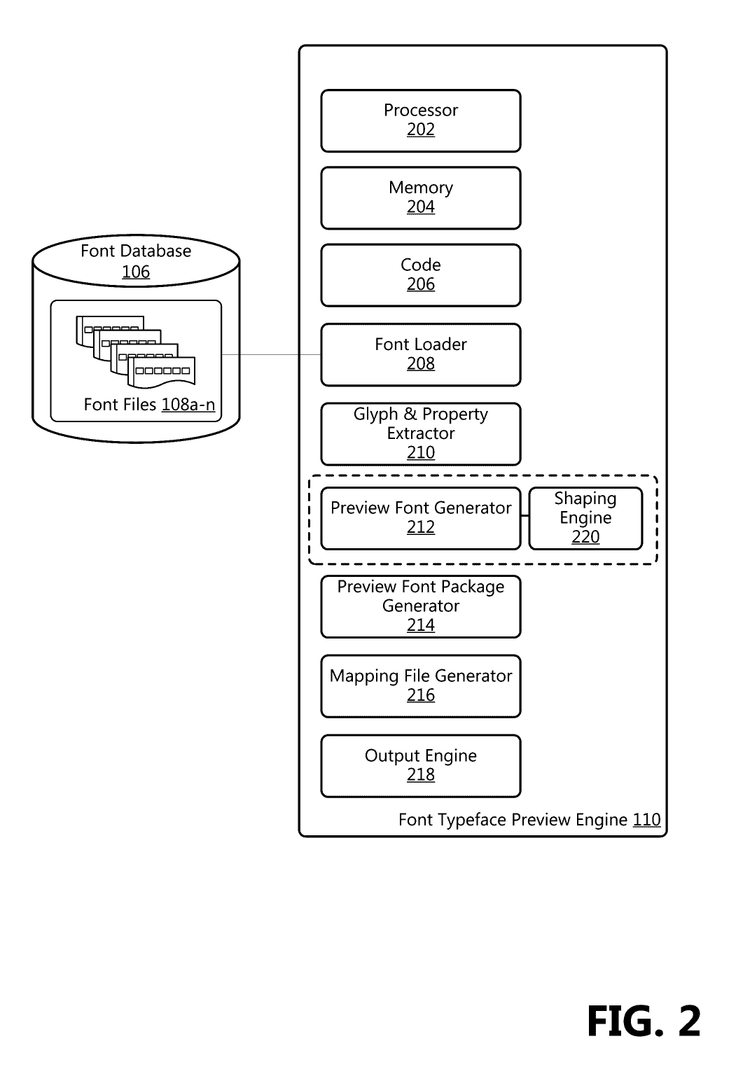

With reference now to FIG. 2, a simplified block diagram illustrating components of the font typeface preview engine 110 is shown. According to examples, the font typeface preview engine 110 includes at least one processor 202, at least one memory 204 coupled to the at least one processor 202, and code 206 which is executable by the processor 202 to cause: a font loader 208 to load a plurality of font files 108 from the font database 106; a glyph and property extractor 210 to extract a subset of glyphs and character properties from each of the plurality of font files 108; a preview font generator 212 to generate a single-glyph font typeface preview element 124 for each font from each subset of glyphs according to the character properties; a preview font package generator 214 to generate a preview font file 112 and store the generated font typeface preview elements 124 in the preview font file 112; a mapping file generator 216 to map each available font to a location of its associated font typeface preview element 124 in the preview font file 112; and an output engine 218 to provide the preview font file 112 to a client application 118.

According to examples, the font loader 208 is illustrative of a software module, system, or device that is in communicatively attached to the font database 106 and operable to access and retrieve a plurality of font files 108 from the font database 106. As described above, the font database 106 is illustrative of a general purpose data storage unit or system for storing a plurality of font files 108, wherein each font file 108 comprises a collection of glyphs of a font and character properties associated with the font.

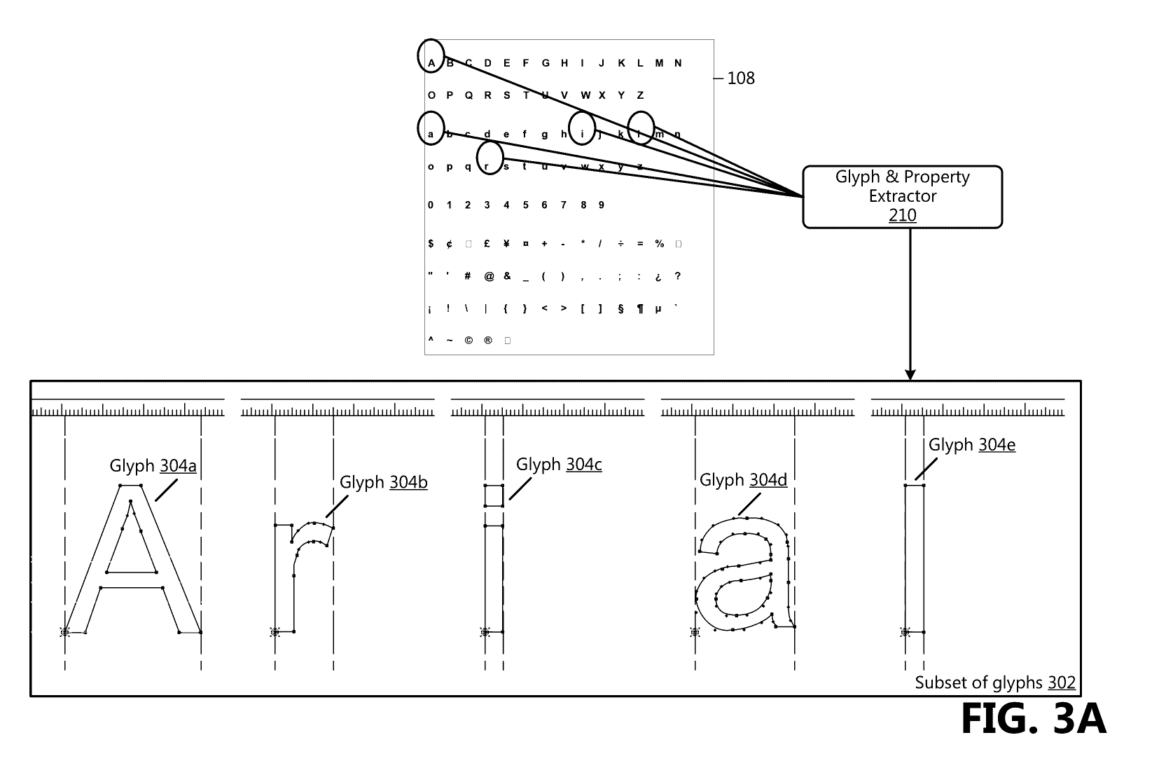

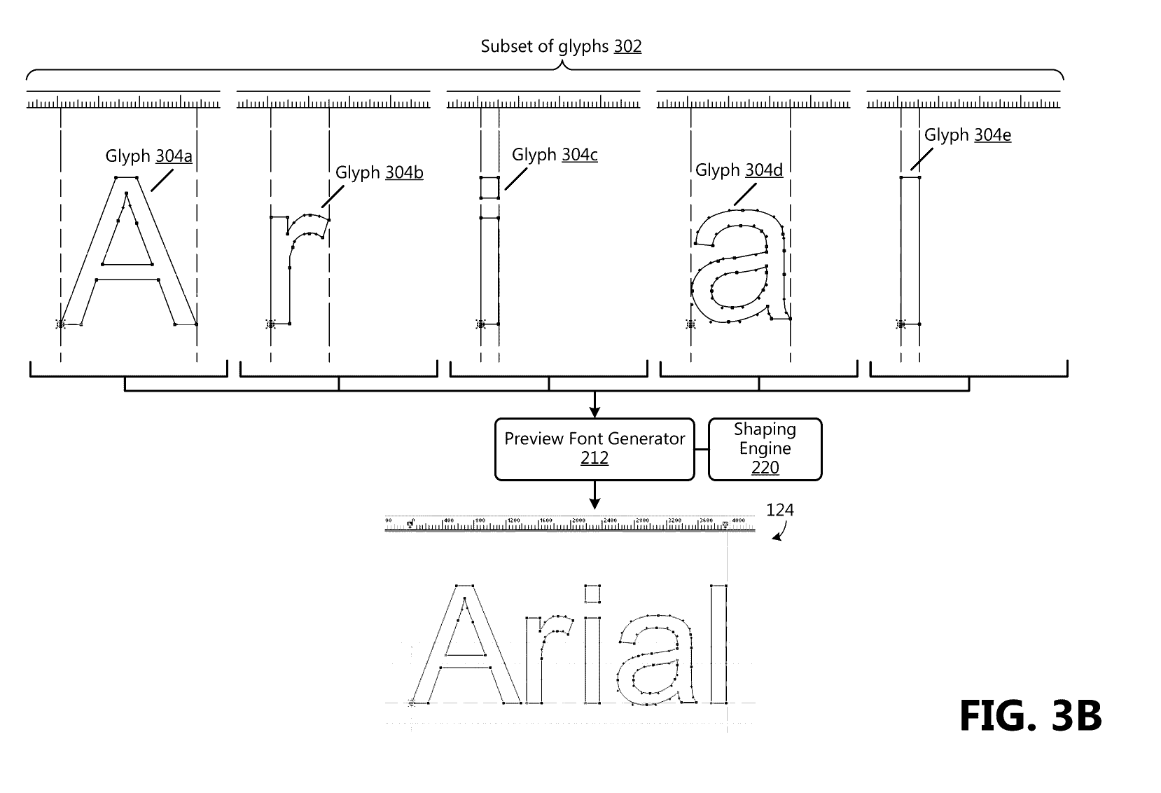

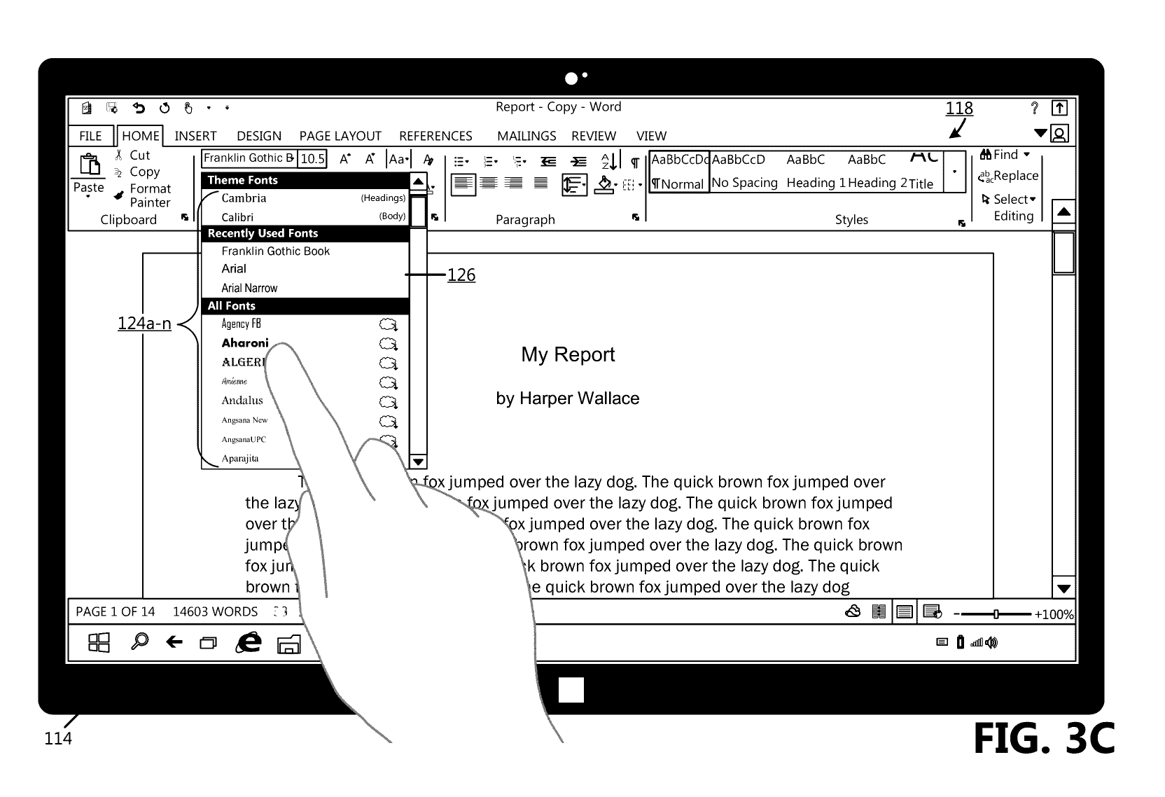

According to examples, the glyph and property extractor 210 is illustrative of a software module, system, or device operable to determine a subset of glyphs to extract from each font file 108, and to extract the subsets of glyphs. In some examples, the glyph and property extractor 210 extracts the glyphs that comprise the name of the font. For example and with reference to FIG. 3A, for the font “Arial,” the subset of glyphs 302 that the glyph and property extractor 210 extracts includes the “A,” “r,” “i,” “a,” and “I” glyphs 304a-e (collectively, 304) from the Arial font file 108. Additionally, the glyph and property extractor 210 extracts the character properties associated with the font.

Referring back to FIG. 2, according to examples, the preview font generator 212 is illustrative of a software module, system, or device operable to, for each subset of glyphs 302, combine the glyphs 304 into a single glyph. Thus, the preview font generator 212 generates a font typeface preview element 124 for each subset of glyphs 302 extracted from the font files 108. For example, and with reference to FIG. 3B, the preview font generator 212 combines the subset of glyphs 302 into a single-glyph font typeface preview element 124 that includes glyphs 302 in the font's typeface and that is representative of the font stored in the font file 108. In the illustrated example, the subset of glyphs 302 includes the “A,” “r,” “i,” “a,” and “I” glyphs 304 from the Arial font file 108.

According to one aspect, the preview font generator 212 is in communication with a shaping engine 220. According to another aspect, the preview font generator 212 includes a shaping engine 220. The shaping engine 220 is operable to consult the character properties extracted by the glyph and property extractor 210, and space, shape, position, and contextually reorder the glyphs 304 in the subset of glyphs 302 in accordance with the character properties. For example, the character properties include logic associated with spacing, shaping, positioning, special behaviors, or contextual reordering. In some examples, the character properties further include logic associated with language-specific properties. The preview font generator 212, in conjunction with the shaping engine 220, generates a plurality of single-glyph font typeface preview elements 124 that are accurate representations of the fonts in the font files 108 stored in the font database 106.

With reference again to FIG. 2, according to examples, the preview font package generator 214 is illustrative of a software module, system, or device operable to collect the plurality of font typeface preview elements 124, and package them into a preview font file 112. That is, the preview font package generator 214 stores the plurality of font typeface preview elements 124 representative of the fonts in the font files 108 in a single file that can be transmitted to a client computing device 114.

According to examples, the mapping file generator 216 is illustrative of a software module, system, or device operable to generate a mapping file 116 that maps each font to the location of its associated font typeface preview element 124 in the preview font file 112. For example, the mapping file 116 is a mapping table.

According to examples, the output engine 218 is illustrative of a software module, system, or device operable to provide the preview font file 112 comprising the generated font typeface preview elements 124 and the mapping file 116 to one or more client applications 118. In some examples, the output engine 218 is operable to transmit the preview font file 112 to a client application 118 executing on a client computing device 114 over a distributed computing network 120, such as the Internet or an intranet. Accordingly, the client computing device 114 is operable to receive the preview font file 112 and the mapping file 116 (e.g., download the preview font file 112 and mapping file 116), and store the preview font file 112 and the mapping file 116 in a local data repository 122 such that the font typeface preview elements 124 and the mapping file 116 are available for use by the one or more applications 118 executing on the client computing device 114.

In other examples, the output engine 218 is operable to provide the preview font file 112 and the mapping file 116 for packaging the preview font file 112 and the mapping file 116 with a client application 118 at build time.

For example and with reference to FIG. 3C, a user may utilize an application 118, such as a word processing application, executing on a client computing device 114, wherein the computing device 114 includes a data repository 122, within which a preview font file 112 comprising a plurality of font typeface preview elements 124 and a mapping file 116 are stored. Accordingly, when an indication of a selection is made to display a listing of available fonts, for example, when a user selects a font selection command from a user interface toolbar or menu, the application 118 reads the mapping file 116 to determine the locations of the font typeface preview elements 124 associated with the fonts to display in the font selection menu 126, retrieves the font typeface preview elements 124 from their storage locations, and renders the font typeface preview elements 124a-n in the font selection menu 126 as illustrated in FIG. 3C.

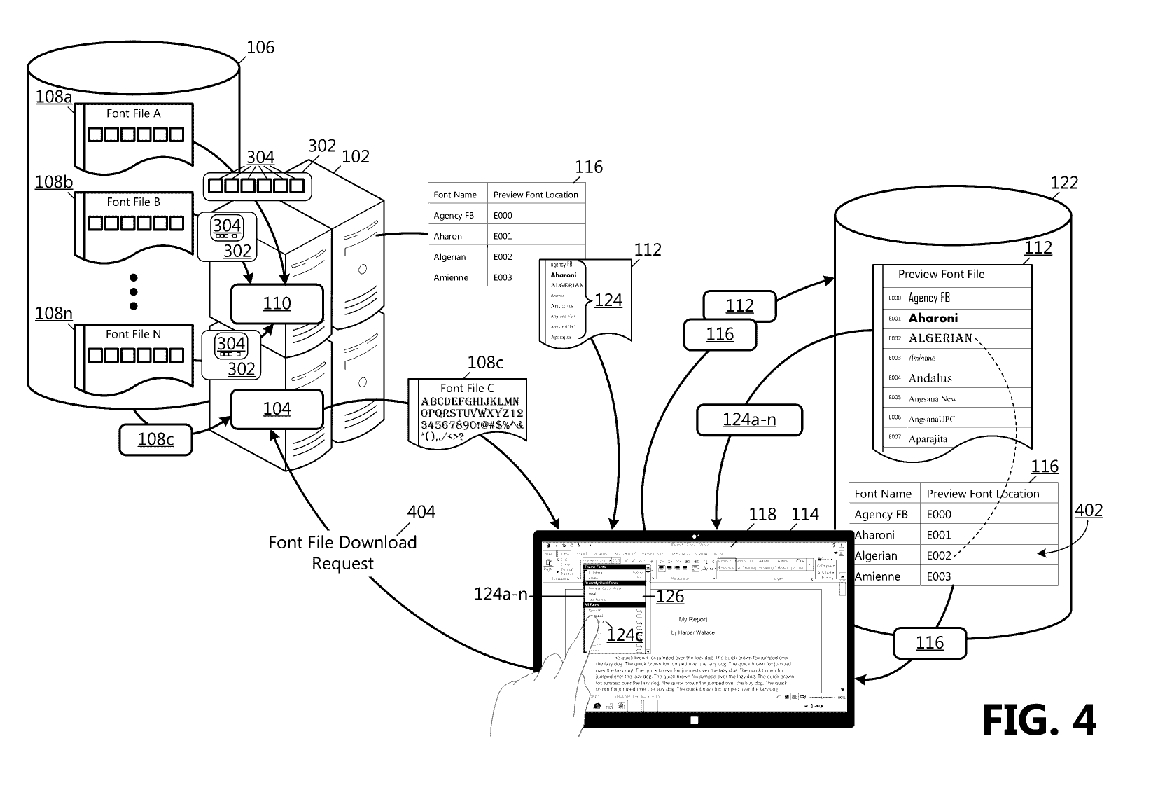

With reference now to FIG. 4, a graphical representation of a flow of data in an example font typeface preview element generation system is shown. As illustrated, for each font file 108 stored in the font database 106, a subset of glyphs 302 are extracted by and are transmitted to the font typeface preview engine 110. As described above, each subset of glyphs 302 comprises a plurality of glyphs 304 that, when grouped together, are a representation of a font stored in the font file 108. In some examples, the glyphs 304 in a subset of glyphs 302 form the letters in the font's name.

After the font typeface preview engine 110 generates a plurality of font typeface preview elements 124, packages the plurality of font typeface preview elements 124 in a preview font file 112, and generates a mapping file 116 including location data 402 that maps each of the font to the locations of the font typeface preview elements 124 in the preview font file 112, the font typeface preview engine 110 outputs the preview font file 112 and the mapping file 116 to a client application 118 executing on a client computing device 114. The client computing device 114 then stores the preview font file 112 and the mapping file 116 in a data repository 122 associated with the client computing device 114.

When an indication of a selection to view a listing of fonts available to a client application 118 is received, the client application 118 reads the location data 402 in the mapping file 116 for the locations of the font typeface preview elements 124 for the fonts available to the client application 118. The client application 118 then retrieves the font typeface preview elements 124 from the preview font file 112 for displaying the font typeface preview elements 124 in a font selection menu 126.

When an indication of a selection of a font typeface preview element 124 in the font selection menu 126 is received, the client application 118 sends a request 404 to the font manager 104 for the font file 108 associated with the font represented by the selected font typeface preview element 124. For example, if the user selects font typeface preview element 124c, which is representative of the Algerian font, the client application 118 sends a request 404 to the font manager 104 for the font file 108c for the Algerian font. The font manager 104 retrieves the font file 108c residing in the font database 106, and transports the font file 108c to the client application 118.

Having described an operating environment, a data flow example, and various aspects with respect to FIGS. 1-4, FIG. 5A illustrates a flow chart showing general stages involved in an example method for generating and providing an independent preview font file 112 for presenting font typeface preview elements 124 representative of cloud-based fonts in a font selection menu 126. The method 500 begins at start operation 505 and proceeds to a file loading operation 510, where the font loader 208 accesses and retrieves a plurality of font files 108 from the font database 106, wherein the font files 108 comprise glyphs 304 of fonts and character properties.

The method 500 continues to an extraction operation 515, where the glyph and property extractor 210 determines which glyphs 304 to extract from the font files 108, and extracts the determined subsets of glyphs 302 and character properties from each font file 108. According to an aspect, the determination of which glyphs 304 to extract from a font file 108 is made according to the representation of the font that is desired. For example, if the name of a font is the desired representation of the font, the glyph and property extractor 210 extracts the glyphs 304 that comprise the name of the font (e.g., the “A,” “r,” “i,” “a,” and “I” glyphs 304a-e are extracted from the Arial font file 108). According to another aspect, the determination of which glyphs 304 to extract from a font file 108 is made according to a particular language or location. For example, for a particular region or language, certain fonts may be available. Additionally, it may be desired for the fonts to be represented in a particular language using glyphs 304 of the particular language (e.g., Japanese characters).

The method 500 continues to a preview element generation operation 520, where, for each subset of glyphs 302, the preview font generator 212 combines the glyphs 304 into a single-glyph font typeface preview element 124. According to an example, the preview font generator 212 employs a shaping engine 220 to consult the character properties associated with spacing, shaping, positioning, special behaviors, or contextual reordering, and space, shape, position, or reorder the glyphs 304 in the subset of glyphs 302, or apply special behavior to the glyphs 304 in the subset of glyphs 302 in accordance with the character properties.

The method 500 continues to a packaging operation 525, where the preview font package generator 214 collects the plurality of font typeface preview elements 124 generated by the preview font generator 212, and packages the plurality of font typeface preview elements 124 into a preview font file 112.

The method 500 continues to a mapping file generation operation 530, where the mapping file generator 216 generates a mapping file 116 that maps each font of the plurality of font files 108 to the location of its associated font typeface preview element 124 in the preview font file 112.

The method 500 continues to a transmission operation 535, where the output engine 218 provides the preview font file 112 to a client application 118. In some examples, the output engine 218 transmits the preview font file 112 and the mapping file 116 to a client application 118 executing on a client computing device 114 over a distributed computing network 120 in response to receiving a request for the client application 118 to download the preview font file 112 and the mapping file 116. In other examples, the output engine 218 provides the preview font file 112 and the mapping file 116 to a font manager 104 for packaging the preview font file 112 and the mapping file 116 with a client application 118 at build time. Accordingly, a client application 118 executing on the client computing device 114 is enabled to access the plurality of font typeface preview elements 124 in the preview font file 112 for displaying font typeface preview elements 124 in a font selection menu 126.

For example, the client application 118 reads the mapping file 116 for finding the storage locations of the font typeface preview elements 124 associated with the fonts that are available to the client application 118, pulls the associated font typeface preview elements 124 from the preview font file 112, and renders the font typeface preview elements 124 in the font selection menu 126. Accordingly, the fonts are represented in their own typographies. A user of the client application 118 is enabled to see an accurate representation of the available fonts.

The method 500 ends at OPERATION 540.

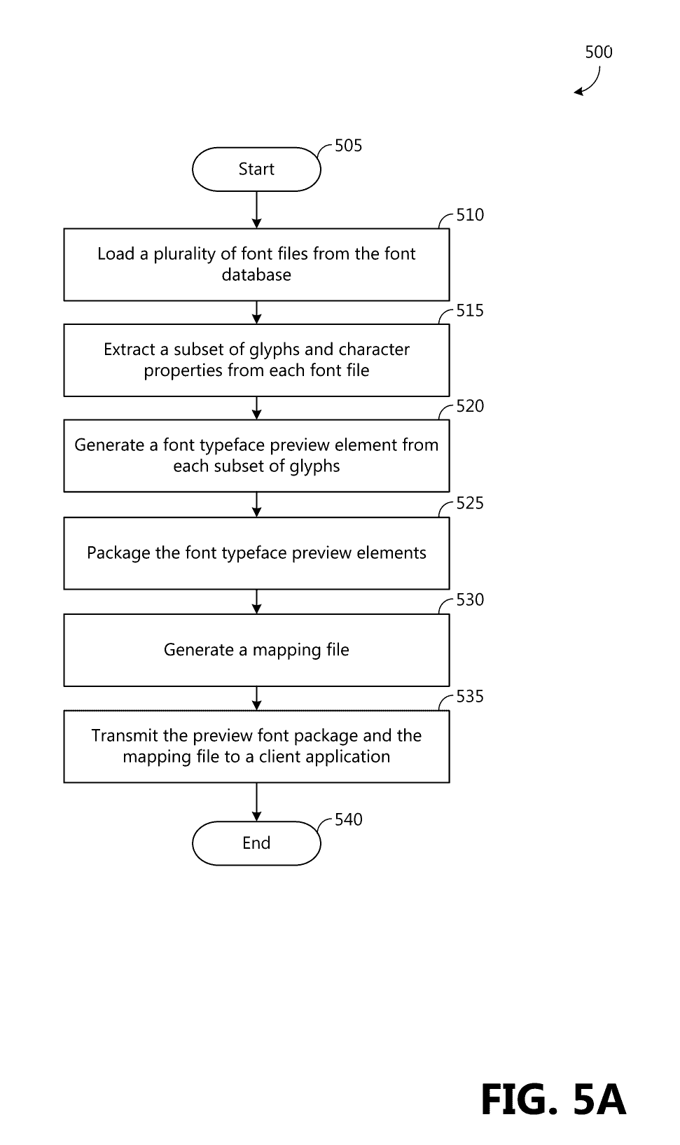

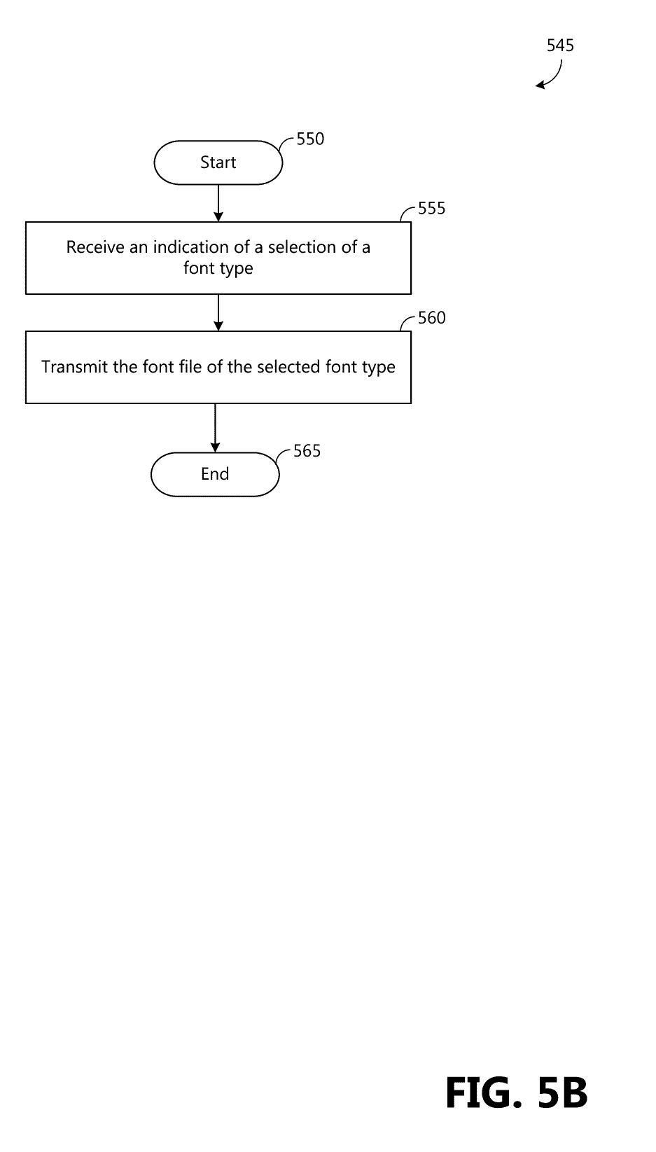

FIG. 5B illustrates a flow chart showing general stages involved in an example method 545 for providing a font file 108 to a client application 118 executing on a client computing device 114. In some examples, the example method 545 is a continuation from the transmission operation 535 of the example method 500 illustrated in FIG. 5A.

The method 545 begins at start operation 550 and proceeds to a selection operation 555, where an indication of a selection of a font is received. According to examples, the indication of the selection of the font is in response to a selection made by a user of a font typeface preview element 124 in a font selection menu 126, wherein the font typeface preview element 124 is associated with the font. According to examples, the indication of the selection is communicated to the font manager 104 via a client application 118 executing on a client computing device 114.

The method 545 continues to a transmission operation 560, where the font file 108 including the glyphs 304 and character properties of the selected font are transmitted to the client application 118 executing on the client computing device 114. Accordingly, the client application 118 is enabled to utilize the selected font for rendering glyphs and characters in the typeface of the font.

The method 545 ends at OPERATION 565.

While implementations have been described in the general context of program modules that execute in conjunction with an application program that runs on an operating system on a computer, those skilled in the art will recognize that aspects may also be implemented in combination with other program modules. Generally, program modules include routines, programs, components, data structures, and other types of structures that perform particular tasks or implement particular abstract data types.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, according to an aspect, the aspects and functionalities described herein operate over distributed systems (e.g., cloud-based computing systems), where application functionality, memory, data storage and retrieval and various processing functions are operated remotely from each other over a distributed computing network, such as the Internet or an intranet. According to an aspect, user interfaces and information of various types are displayed via on-board computing device displays or via remote display units associated with one or more computing devices. For example, user interfaces and information of various types are displayed and interacted with on a wall surface onto which user interfaces and information of various types are projected. Interaction with the multitude of computing systems with which implementations are practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

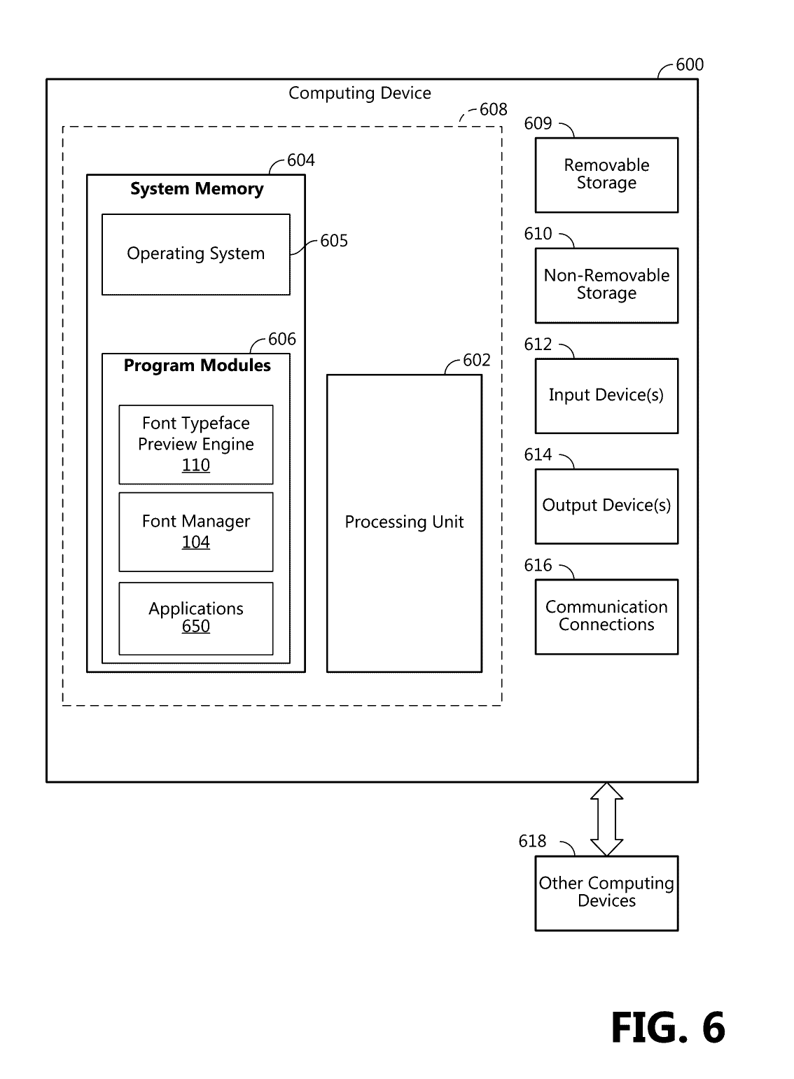

FIG. 6-8 and the associated descriptions provide a discussion of a variety of operating environments in which examples are practiced. However, the devices and systems illustrated and discussed with respect to FIGS. 6-8 are for purposes of example and illustration and are not limiting of a vast number of computing device configurations that are utilized for practicing aspects, described herein.

FIG. 6 is a block diagram illustrating physical components (i.e., hardware) of a computing device 600 with which examples of the present disclosure are be practiced. In a basic configuration, the computing device 600 includes at least one processing unit 602 and a system memory 604. According to an aspect, depending on the configuration and type of computing device, the system memory 604 comprises, but is not limited to, volatile storage (e.g., random access memory), non-volatile storage (e.g., read-only memory), flash memory, or any combination of such memories. According to an aspect, the system memory 604 includes an operating system 605 and one or more program modules 606 suitable for running software applications 650. According to an aspect, the system memory 604 includes the font typeface preview engine 110 and font manager 104. The operating system 605, for example, is suitable for controlling the operation of the computing device 600. Furthermore, aspects are practiced in conjunction with a graphics library, other operating systems, or any other application program, and is not limited to any particular application or system. This basic configuration is illustrated in FIG. 6 by those components within a dashed line 608. According to an aspect, the computing device 600 has additional features or functionality. For example, according to an aspect, the computing device 600 includes additional data storage devices (removable and/or non-removable) such as, for example, magnetic disks, optical disks, or tape. Such additional storage is illustrated in FIG. 6 by a removable storage device 609 and a non-removable storage device 610.

As stated above, according to an aspect, a number of program modules and data files are stored in the system memory 604. While executing on the processing unit 602, the program modules 606 (e.g., font typeface preview engine 110 and font manager 104) perform processes including, but not limited to, one or more of the stages of the methods 500 and 545 illustrated in FIGS. 5A and 5B. According to an aspect, other program modules are used in accordance with examples and include applications such as electronic mail and contacts applications, word processing applications, spreadsheet applications, database applications, slide presentation applications, drawing or computer-aided application programs, etc.

According to an aspect, aspects are practiced in an electrical circuit comprising discrete electronic elements, packaged or integrated electronic chips containing logic gates, a circuit utilizing a microprocessor, or on a single chip containing electronic elements or microprocessors. For example, aspects are practiced via a system-on-a-chip (SOC) where each or many of the components illustrated in FIG. 6 are integrated onto a single integrated circuit. According to an aspect, such an SOC device includes one or more processing units, graphics units, communications units, system virtualization units and various application functionality all of which are integrated (or “burned”) onto the chip substrate as a single integrated circuit. When operating via an SOC, the functionality, described herein, is operated via application-specific logic integrated with other components of the computing device 600 on the single integrated circuit (chip). According to an aspect, aspects of the present disclosure are practiced using other technologies capable of performing logical operations such as, for example, AND, OR, and NOT, including but not limited to mechanical, optical, fluidic, and quantum technologies. In addition, aspects are practiced within a general purpose computer or in any other circuits or systems.

According to an aspect, the computing device 600 has one or more input device(s) 612 such as a keyboard, a mouse, a pen, a sound input device, a touch input device, etc. The output device(s) 614 such as a display, speakers, a printer, etc. are also included according to an aspect. The aforementioned devices are examples and others may be used. According to an aspect, the computing device 600 includes one or more communication connections 616 allowing communications with other computing devices 618. Examples of suitable communication connections 616 include, but are not limited to, radio frequency (RF) transmitter, receiver, and/or transceiver circuitry; universal serial bus (USB), parallel, and/or serial ports.

The term computer readable media as used herein include computer storage media. Computer storage media include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (i.e., memory storage.) According to an aspect, computer storage media includes RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. According to an aspect, any such computer storage media is part of the computing device 600. Computer storage media does not include a carrier wave or other propagated data signal.

According to an aspect, communication media is embodied by computer readable instructions, data structures, program modules, or other data in a modulated data signal, such as a carrier wave or other transport mechanism, and includes any information delivery media. According to an aspect, the term “modulated data signal” describes a signal that has one or more characteristics set or changed in such a manner as to encode information in the signal. By way of example, and not limitation, communication media includes wired media such as a wired network or direct-wired connection, and wireless media such as acoustic, radio frequency (RF), infrared, and other wireless media.

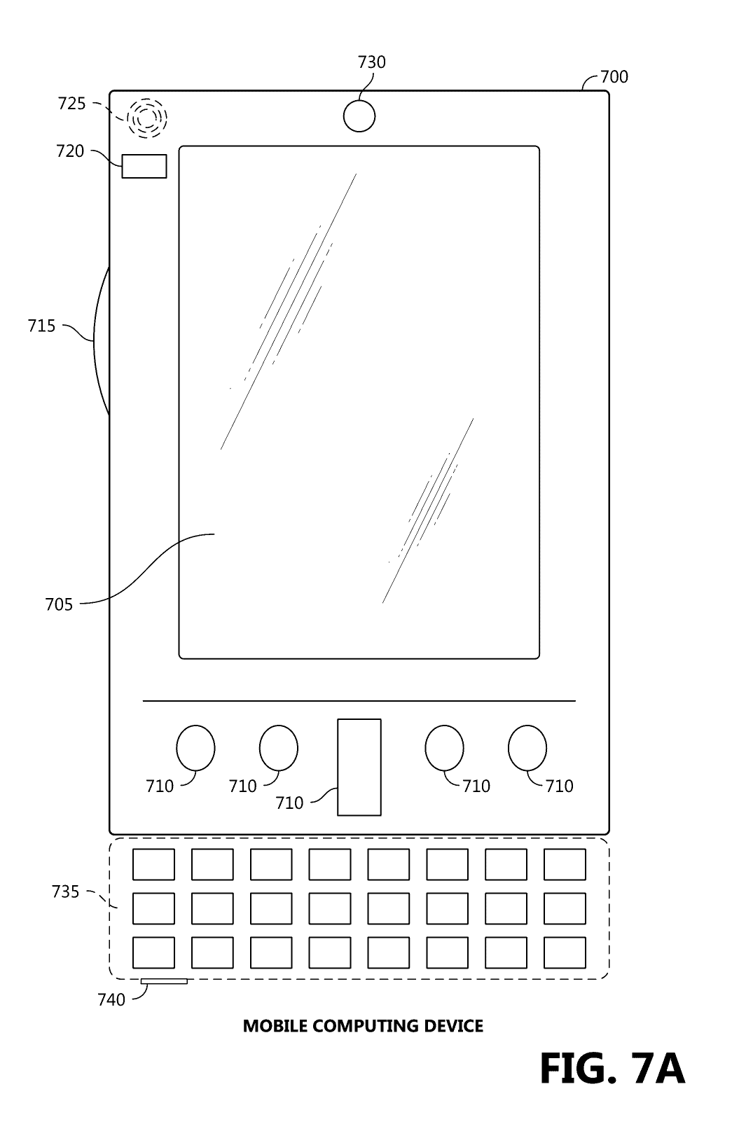

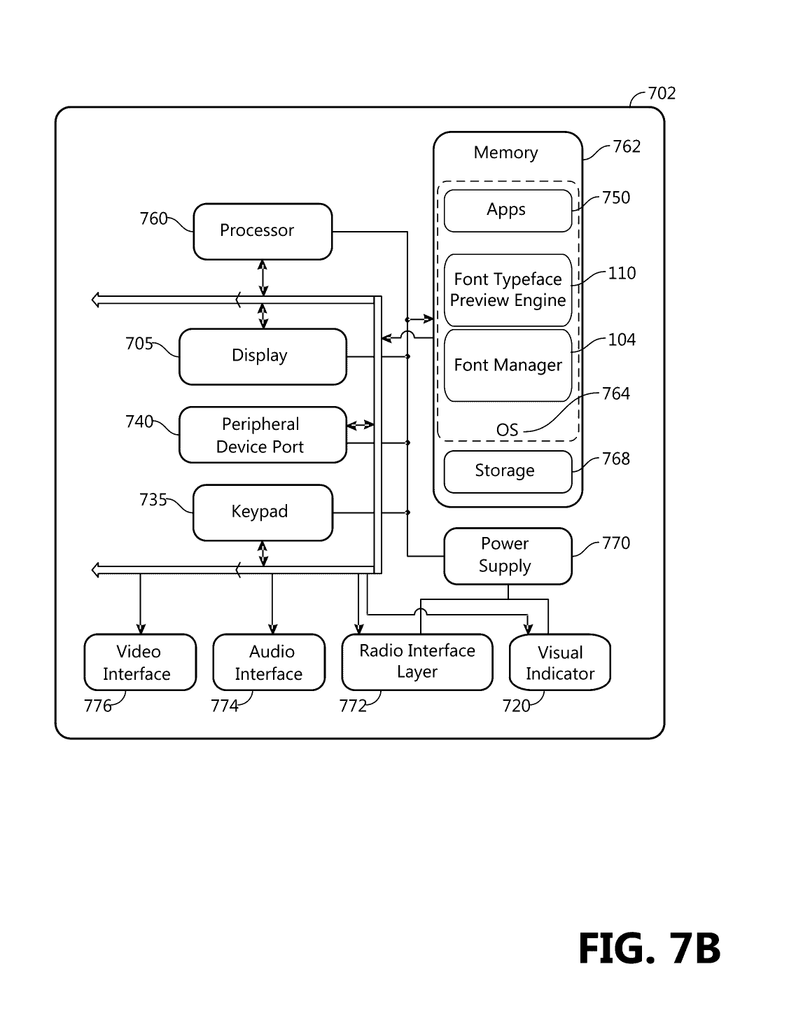

FIGS. 7A and 7B illustrate a mobile computing device 700, for example, a mobile telephone, a smart phone, a tablet personal computer, a laptop computer, and the like, with which aspects may be practiced. With reference to FIG. 7A, an example of a mobile computing device 700 for implementing the aspects is illustrated. In a basic configuration, the mobile computing device 700 is a handheld computer having both input elements and output elements. The mobile computing device 700 typically includes a display 705 and one or more input buttons 710 that allow the user to enter information into the mobile computing device 700. According to an aspect, the display 705 of the mobile computing device 700 functions as an input device (e.g., a touch screen display). If included, an optional side input element 715 allows further user input. According to an aspect, the side input element 715 is a rotary switch, a button, or any other type of manual input element. In alternative examples, mobile computing device 700 incorporates more or fewer input elements. For example, the display 705 may not be a touch screen in some examples. In alternative examples, the mobile computing device 700 is a portable phone system, such as a cellular phone. According to an aspect, the mobile computing device 700 includes an optional keypad 735. According to an aspect, the optional keypad 735 is a physical keypad. According to another aspect, the optional keypad 735 is a “soft” keypad generated on the touch screen display. In various aspects, the output elements include the display 705 for showing a graphical user interface (GUI), a visual indicator 720 (e.g., a light emitting diode), and/or an audio transducer 725 (e.g., a speaker). In some examples, the mobile computing device 700 incorporates a vibration transducer for providing the user with tactile feedback. In yet another example, the mobile computing device 700 incorporates input and/or output ports, such as an audio input (e.g., a microphone jack), an audio output (e.g., a headphone jack), and a video output (e.g., a HDMI port) for sending signals to or receiving signals from an external device. In yet another example, the mobile computing device 700 incorporates peripheral device port 740, such as an audio input (e.g., a microphone jack), an audio output (e.g., a headphone jack), and a video output (e.g., a HDMI port) for sending signals to or receiving signals from an external device.

FIG. 7B is a block diagram illustrating the architecture of one example of a mobile computing device. That is, the mobile computing device 700 incorporates a system (i.e., an architecture) 702 to implement some examples. In one example, the system 702 is implemented as a “smart phone” capable of running one or more applications (e.g., browser, e-mail, calendaring, contact managers, messaging clients, games, and media clients/players). In some examples, the system 702 is integrated as a computing device, such as an integrated personal digital assistant (PDA) and wireless phone.

According to an aspect, one or more application programs 750 are loaded into the memory 762 and run on or in association with the operating system 764. Examples of the application programs include phone dialer programs, e-mail programs, personal information management (PIM) programs, word processing programs, spreadsheet programs, Internet browser programs, messaging programs, and so forth. According to an aspect, the font typeface preview engine 110 and font manager 104 are loaded into memory 762. The system 702 also includes a non-volatile storage area 768 within the memory 762. The non-volatile storage area 768 is used to store persistent information that should not be lost if the system 702 is powered down. The application programs 750 may use and store information in the non-volatile storage area 768, such as e-mail or other messages used by an e-mail application, and the like. A synchronization application (not shown) also resides on the system 702 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the mobile computing device 700.

According to an aspect, the system 702 has a power supply 770, which is implemented as one or more batteries. According to an aspect, the power supply 770 further includes an external power source, such as an AC adapter or a powered docking cradle that supplements or recharges the batteries.

According to an aspect, the system 702 includes a radio 772 that performs the function of transmitting and receiving radio frequency communications. The radio 772 facilitates wireless connectivity between the system 702 and the “outside world,” via a communications carrier or service provider. Transmissions to and from the radio 772 are conducted under control of the operating system 764. In other words, communications received by the radio 772 may be disseminated to the application programs 750 via the operating system 764, and vice versa.

According to an aspect, the visual indicator 720 is used to provide visual notifications and/or an audio interface 774 is used for producing audible notifications via the audio transducer 725. In the illustrated example, the visual indicator 720 is a light emitting diode (LED) and the audio transducer 725 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. According to an aspect, the system 702 further includes a video interface 776 that enables an operation of an on-board camera 730 to record still images, video stream, and the like.

According to an aspect, a mobile computing device 700 implementing the system 702 has additional features or functionality. For example, the mobile computing device 700 includes additional data storage devices (removable and/or non-removable) such as, magnetic disks, optical disks, or tape. Such additional storage is illustrated in FIG. 7B by the non-volatile storage area 768.

According to an aspect, data/information generated or captured by the mobile computing device 700 and stored via the system 702 is stored locally on the mobile computing device 700, as described above. According to another aspect, the data is stored on any number of storage media that is accessible by the device via the radio 772 or via a wired connection between the mobile computing device 700 and a separate computing device associated with the mobile computing device 700, for example, a server computer in a distributed computing network, such as the Internet. As should be appreciated such data/information is accessible via the mobile computing device 700 via the radio 772 or via a distributed computing network. Similarly, according to an aspect, such data/information is readily transferred between computing devices for storage and use according to well-known data/information transfer and storage means, including electronic mail and collaborative data/information sharing systems.

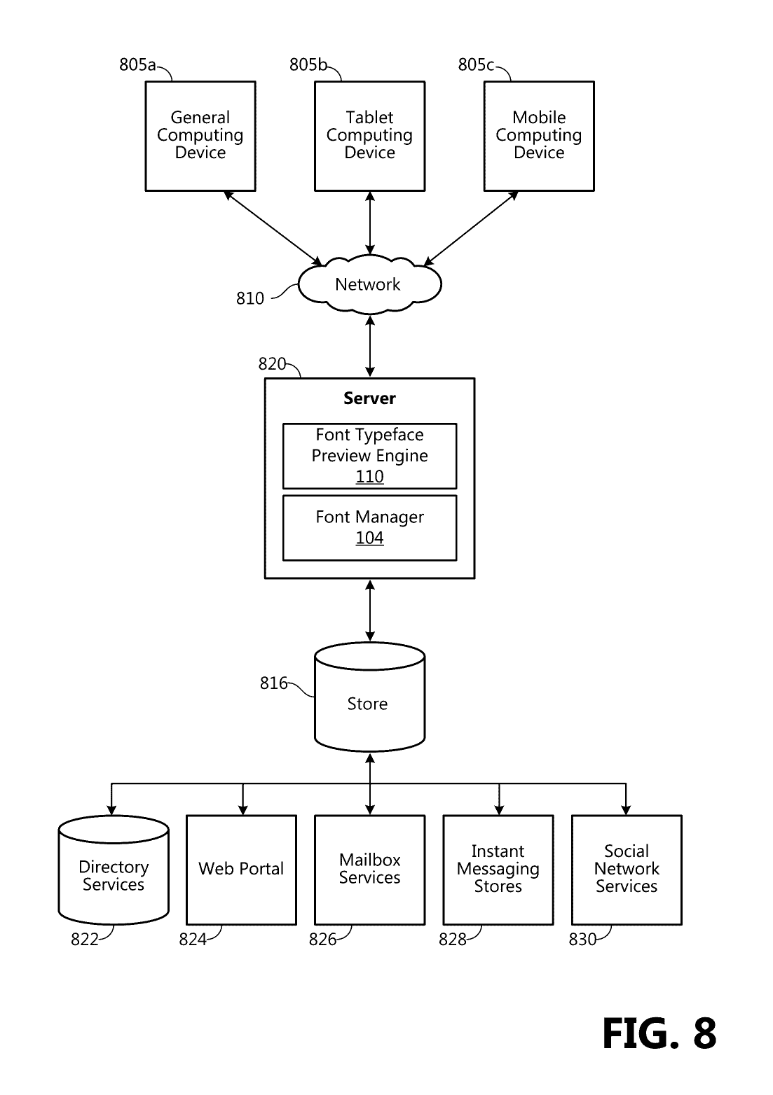

FIG. 8 illustrates one example of the architecture of a system for generating and providing font typeface preview elements 124 representative of cloud-based fonts in a font selection menu 126 as described above. Content developed, interacted with, or edited in association with the font typeface preview engine 110 and font manager 104 is enabled to be stored in different communication channels or other storage types. For example, various documents may be stored using a directory service 822, a web portal 824, a mailbox service 826, an instant messaging store 828, or a social networking site 830. The font typeface preview engine 110 and font manager 104 are operable to use any of these types of systems or the like for generating and providing font typeface preview elements 124 representative of cloud-based fonts in a font selection menu 126, as described herein. According to an aspect, a server 820 provides the font typeface preview engine 110 and font manager 104 to clients 805a,b,c. As one example, the server 820 is a web server providing the font typeface preview engine 110 and font manager 104 over the web. The server 820 provides the font typeface preview engine 110 and font manager 104 over the web to clients 805 through a network 810. By way of example, the client computing device is implemented and embodied in a personal computer 805a, a tablet computing device 805b or a mobile computing device 805c (e.g., a smart phone), or other computing device. Any of these examples of the client computing device are operable to obtain content from the store 816.

Implementations, for example, are described above with reference to block diagrams and/or operational illustrations of methods, systems, and computer program products according to aspects. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more examples provided in this application are not intended to limit or restrict the scope as claimed in any way. The aspects, examples, and details provided in this application are considered sufficient to convey possession and enable others to make and use the best mode. Implementations should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope.

1. A computer-implemented method for generating a preview representative of a font comprising:
generating a preview font file at a font system, the preview font file comprising a plurality of font typeface preview elements, wherein each font typeface preview element is associated with a font;
generating a mapping file comprising location data mapping each font to a storage location of its associated font typeface preview element in the preview font file; and
transmitting the preview font file and the mapping file to a client application executing on a client computing device for rendering the plurality of font typeface preview elements as representations of the fonts in a font selection menu, wherein the client application does not include the fonts represented by the font typeface preview elements.

2. The computer-implemented method of claim 1, wherein generating the preview font file comprises:
loading a plurality of font files, each font file including a plurality of glyphs in a typeface of a font;
extracting a subset of glyphs from each font file;
for each subset of glyphs, generating a font typeface preview element, wherein the font typeface preview element is a representation of the font; and
packaging the font typeface preview elements in the preview font file.

3. The computer-implemented method of claim 2, wherein generating a font typeface preview element comprises combining the subset of glyphs into a single glyph.

4. The computer-implemented method of claim 2, wherein extracting the subset of glyphs from each font file comprises, for each font, extracting each glyph in a name of the font.

5. The computer-implemented method of claim 2, further comprising:
extracting character properties from each font file; and
for each subset of glyphs, generating the font typeface preview element according to the character properties.

6. The computer-implemented method of claim 5, wherein for each subset of glyphs, generating the font typeface preview element according to the character properties comprises at least one of: spacing, shaping, positioning, and contextually reordering the glyphs in the subset of glyphs in accordance with the character properties.

7. The computer-implemented method of claim 1, further comprising providing the preview font file and the mapping file to a client application for rendering the plurality of font typeface preview elements as representations of the fonts in a font selection menu, wherein the client application does not include the fonts represented by the font typeface preview elements.

8. The computer-implemented method of claim 7, wherein providing the preview font file and the mapping file to a client application comprises transmitting the preview font file to the client application, wherein the client application is executing on a client computing device.

9. The computer-implemented method of claim 7, wherein providing the preview font file and the mapping file to a client application comprises providing the preview font file and the mapping file to the client application during build time.

10. The computer-implemented method of claim 7, further comprising:
receiving an indication of a selection of a font; and
transmitting a font file including a plurality of glyphs in a typeface of the selected font to the client application executing on a client computing device.

11. A system for generating a preview representative of a font, comprising:
one or more processors for executing programmed instructions;
memory, coupled to the one or more processors, for storing program instruction steps for execution by the computer processor;
a font typeface preview engine operable to generate a preview font file, the preview font file comprising a plurality of font typeface preview elements, wherein each font typeface preview element is associated with a font, and wherein the font typeface preview engine comprises:
a mapping file generator operable to generate a mapping file comprising location data mapping each font to a storage location of its associated font typeface preview element in the preview font file.

12. The system of claim 11, wherein the font typeface preview engine further comprises:
a font loader operable to load a plurality of font files, each font file including a plurality of glyphs in a typeface of a font type;
a glyph and property extractor operable to extract a subset of glyphs from each font file;
a preview font generator operable to generate a font typeface preview element for each subset of glyphs, wherein each font typeface preview element is a representation of a font type; and
a preview font package generator operable to package the font typeface preview elements in the preview font file.

13. The system of claim 12, wherein in generating a font typeface preview element, the preview font generator is operable to combine the subset of glyphs into a single glyph.

14. The system of claim 12, wherein in extracting the subset of glyphs from each font file, the glyph and property extractor is operable to, for each font type, extract each glyph in a name of the font type.

15. The system of claim 12, wherein the glyph and property extractor is further operable to extract character properties from each font file.

16. The system of claim 15, wherein, for each subset of glyphs, the preview font generator is further operable to generate the font typeface preview element according to the character properties.

17. The system of claim 15, wherein the font typeface preview engine further comprises a shaping engine operable to, for each subset of glyphs:
consult the character properties; and
space, shape, position, or contextually reorder the glyphs in the subset of glyphs in accordance with the character properties.

18. The system of claim 15, wherein the character properties include logic associated with at least one of:
spacing;
shaping;
positioning;
special behaviors; and
contextual reordering.

19. The system of claim 11, wherein the system further comprises:
an output engine operable to provide the preview font file and the mapping file to a client application for rendering the plurality of font typeface preview elements as representations of the fonts in a font selection menu, wherein the client application does not include the fonts represented by the font typeface preview elements; and
a font manager operable to:
receive an indication of a selection of a font; and
transmit a font file including a plurality of glyphs in a typeface of the font to the client application executing on a client computing device.

20. One or more computer storage media storing computer-usable instructions that, when used by one or more computing devices, cause the one or more computing devices to perform a method for generating a preview representative of a font, the method comprising:
generating a preview font file, the preview font file comprising a plurality of font typeface preview elements, wherein each font typeface preview element is associated with a font and wherein generating the preview font file comprises:
loading a plurality of font files, each font file including a plurality of glyphs in a typeface of a font;
extracting a subset of glyphs from each font file;
for each subset of glyphs, combining each glyph in the subset of glyphs into a single glyph for generating a font typeface preview element, wherein the font typeface preview element is a representation of the font; and
packaging the font typeface preview elements in the preview font file;
generating a mapping file comprising location data mapping each font to a storage location of its associated font typeface preview element in the preview font file;
transmitting the preview font file and the mapping file to a client application executing on a client computing device for rendering the plurality of font typeface preview elements as representations of the fonts in a font selection menu, wherein the client application does not include the fonts represented by the font typeface preview elements;
receiving an indication of a selection of a font, the indication of the selection of the font occurring in response to a selection of a font typeface preview element rendered in the font selection menu; and
transmitting a font file including a plurality of glyphs in a typeface of the font to the client application executing on the client computing device.
